(19) United States
(12) Patent Application Publication
(10) Pub. No.: US 2011/0313858 A1
(43) Pub. Date: Dec. 22, 2011

(54) Merchant Supplied Offer to a Consumer within a Predetermined Distance

(75) Inventors: Jay Allen DeWitt, Spokane, WA (US); Dennis Norman Moser, Atherton, CA (US)

(73) Assignee: VISA U.S.A. INC., San Francisco, CA (US)

(21) Appl. No.: 13/219,341

(22) Filed: Aug. 26, 2011

Related U.S. Application Data
(63) Continuation of application No. 11/855,042, filed on Sep. 13, 2007.

(51) Int. Cl. G06Q 30/00

(52) U.S. Cl. 705/14.55

(57) ABSTRACT

A merchant supplies a requested offer for inventory to a consumer when the consumer is within a predetermined distance from the merchant. The merchant transmits a merchant identifier, a description of the inventory of the merchant that the merchant is willing to make an offer on, the offer, and instructions to transmit the offer to the consumer making the request for the inventory when the consumer is within the predetermined distance. The merchant receives notice that the offer has been made to the consumer. The consumer accepts the merchant's offer by entering into a transaction with the merchant for the requested inventory that applies the offer to the transaction. The value of the offer may be based on a parameter such as the transaction history of an account associated with the consumer within a payment processing system.

### CROSS-REFERENCE TO RELATED APPLICATIONS

This application is a continuation of U.S. patent application Ser. No. 11/855,042, filed Sep. 13, 2007 and entitled “Merchant Supplied Offer to a Consumer within a Predetermined Distance,” the disclosure of which application is hereby incorporated herein by reference in its entirety.

### BACKGROUND

Merchants deliver offers to consumers through various venues. One example widely used today is the newspaper coupon. Manufacturers and retailers also distribute coupons to potential consumers as part of their sales promotions, such as through the mail, magazines, newspapers, and more recently, through printable versions of the coupon available on the Internet.

Another example of a merchant offer is one presented through a loyalty program. Loyalty programs provide consumers with incentives to shop at certain loyalty program participating facilities or to show loyalty to a particular merchant or service provider, such as a financial institution. In addition to receiving discounts or financial awards, an incentive may include redeemable goods or services. Success of a loyalty program can be measured by how well it targets users that will participate in the program in order to receive the incentives described and provided as part of the loyalty program.

Current merchant offers have a number of drawbacks. Typically, there is a significant time delay between the merchant offer and the consumer purchase. For example, the paper coupon must be printed and delivered to a consumer. Moreover, the consumer may need to remember to have the coupon in hand when making an eligible purchase in order to gain the benefit of the offer presented in the coupon. Similarly, in a loyalty program, points are often accumulated over time in order to redeem an incentive associated with the loyalty program.

Another drawback of current merchant offers is that the merchant offer is typically driven by the merchant—not the consumer. Coupons and loyalty programs often reflect the merchant's prophetic estimation on what its consumer base may be interested in buying at a particular purchase price or points that its consumer base may be willing to pay.

It would be an advance in the art to provide a merchant offer that lessens the foregoing drawbacks.

### SUMMARY

An offeror, such as a merchant, makes an offer to an offeree, such as a consumer, in response to the offeree's request for an offer. When the offeree is within a predetermined distance from the offeror, the offer is made. Implementations provide for an offeree to request the offer for a specific good or service, or a category thereof. When the offeree has received the offer requested from an offeror, that offer can be used by the offeree to consummate a purchase of the good and service with the offeror who made the offer to the offeree.

In one implementation, a first transmission to an automated communication system is formed. The first transmission can include an identifier of the merchant, a description of an inventory of the merchant, and an offer for the inventory to be made to the consumer when the consumer makes a request for the inventory. The description of the inventory may be a price or quantity of a good or service, for example. The offer may be based, for example, on a predetermined distance or a transaction history of an account within a payment processing system. The predetermined distance may be a distance between the merchant (e.g., a point of service of the merchant or the location of the inventory) and the consumer device requesting the inventory. The first transmission may also include instructions that the offer be transmitted to the consumer when the consumer is within the predetermined distance from the merchant. A second transmission addressed from the automated communication system is received providing a notice that the offer was made. Means for performing each of the steps are also provided. The consumer may conduct a transaction with the merchant using an account within a payment processing system. The value of the transaction can be altered based on the offer.

In another implementation, a computer readable medium comprising instruction which, when executed by a computer, can perform a method for providing offers to consumers. The method may comprise forming a first transmission, addressed to an automated communication system that includes: an identifier of a merchant; a description of inventory of the merchant; an offer for the inventory to be made to one or more consumers who have made a request for the inventory; and instructions to the automated communication system to transmit the offer to any of the consumer who is also within a predetermined distance from the merchant. If, after the forming of the first transmission, the inventory of the merchant becomes unavailable, a third transmission can be formed, addressed to the automated communication system, and including instructions not to transmit the offer to any of the consumer who is also within the predetermined distance from the merchant. A fourth transmission can be received that is addressed from the automated communication system, and providing a notice when the offer was transmitted to the consumer. If after the forming of the fourth transmission, the inventory of the merchant becomes unavailable, fifth transmission can be formed, addressed to the automated communication system, and including instructions to the automated communication system to transmit a revocation of the offer for the inventory to any of the consumers to whom the offer was transmitted who has not as of yet accepted the offer.

In yet another implementation, a method is provided in which a first transmission is formed that is addressed to an automated communication system. The first transmission can include an identifier of a merchant; a description of inventory of the merchant; and instructions that a second transmission be formed when a consumer having made a request for a requested inventory matching the inventory of the merchant is within a predetermined distance from the merchant, wherein the second transmission includes a notice that the consumer is within the predetermined distance from the merchant. The second transmission can be received when the consumer is within the predetermined distance from the merchant from the merchant. An offer for the requested inventory can be derived. A third transmission can be formed, addressed to the automated communication system, including the offer for the requested inventory and instructions that the offer for the requested inventory to be included in a fourth transmission addressed to the consumer and to be sent when the consumer is located within the predetermined distance from the merchant.

In yet another implementation, a method is provided in which a first transmission, addressed to an automated communication system, and including: an identifier of a merchant and instructions that a second transmission be formed when a consumer having made a request for a requested inventory is within a predetermined distance from the merchant, wherein the second transmission includes a notice that the consumer is within the predetermined distance and a description of the requested inventory. The second transmission can be received. The requested inventory can be matched with an inventory of the merchant. An offer for the requested inventory can be derived. A third transmission can be formed, addressed to the automated communication system, including the offer for the requested inventory and instructions that the offer for the requested inventory to be included in a fourth transmission addressed to the consumer and to be sent when the consumer is located within the predetermined distance from the merchant.

The offer may also be based on other parameters. For example, the offer may be a function of: a competitor distance between the consumer and a competitor of the merchant, a current quantity of the inventory that the merchant has in-stock, a characteristic of the account, or a combination of the foregoing.

As such, the consumer offeree is likely to receive an offer for inventory that the consumer is interested in taking advantage of because the offer has been specifically tailored by the merchant offeror to an attribute of the consumer offeree—such as the present location or past shopping behavior of the consumer offeree and it is provided when the consumer is close enough to make the purchase. Implementations inherently open new opportunities for merchants to become aware of consumers likely to make purchases for inventory, while each consumer is likely to be rewarded with personalized offers likely to be attractive on the basis of the consumer's past purchasing history.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a block diagram illustrating an exemplary system for a merchant to offer to sell inventory in response to a request by a consumer to buy the inventory;

FIG. 2 is a flow chart illustrating an exemplary process through which consumer's request for inventory can be met with a merchant's offer to sell the requested inventory in the environment of the system illustrated in FIG. 1;

FIG. 3 is a flow chart illustrating an exemplary process for supplying an offer incident to a consumer request for inventory, where the offer is transmitted to the consumer when the consumer is within the predetermined distance from the merchant within the environment of the system illustrated in FIG. 1; and

FIG. 4 is a block level diagram illustrating an exemplary payment processing system which can be used by a consumer offeree executing a transaction for an offer made by a merchant offeror within the environment of the system illustrated in FIG. 1.

### DETAILED DESCRIPTION

Implementations enable a consumer to request an offer for inventory, such as a good or service. The offer may be a percentage off of a purchase price of the inventory, a cash back when the inventory is purchased, a spend-and-get promotion in which the consumer receives free goods or services based on the amount of the inventory purchased. Other types of offer are be readily apparent to those of ordinary skill in the art. To do so, the consumer may use a consumer device that transmits information including the request, the location of the consumer device, information corresponding to an account in a payment processing system, or a return address. The transmission goes to a Requested Offer Supplier (ROS) that will match the requested inventory to a set of merchants that may be: (i) located within a predetermined distance to the consumer device; (ii) have inventory matching the request, and (iii) are willing to make an offer to the consumer that corresponds to the requested inventory. The merchant can provide the consumer a consumer requested offer for the inventory based on business rules delineating conditions for making the offer and parameters that determine the value of the offer such as an offer of ten percent (10%) off the purchase price of consumer requested inventory when the consumer is less than 1 mile from the merchant's store or has purchased the same inventory in the past on the consumer's account in the payment processing system. The offer may include, for example, the location of the merchant, the description of the inventory of the merchant; a discounted purchase value redeemable upon a transaction for the purchase of the inventory of the merchant from the merchant; a confirmation code for the offer; or an identifier for the offer.

In response to the consumer making a request for inventory and the consumer being within the predetermined distance from the merchant, the ROS transmits the offer to the consumer via the return address. The consumer may then travel to the merchant offering the offer and conduct a transaction for the requested inventory that applies the offer to the transaction. As such, the merchant's sales volume increases while the consumer realizes benefit from acting upon the offer.

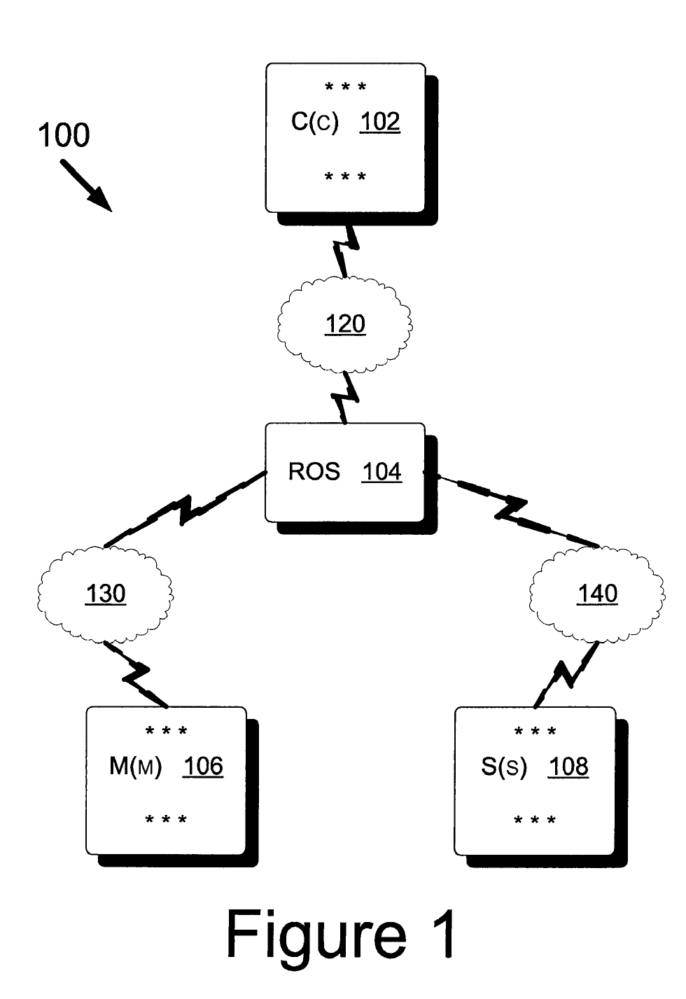

Referring to FIG. 1, an exemplary automated communication system 100 is illustrated for supplying a requested offer that is transmitted to the consumer when the consumer is within the predetermined distance from a merchant M(m) 106.

A consumer, such as a person, a group of persons, a business entity, or a person representing an entity, may have a consumer device. As seen in FIG. 1, each consumer device is represented by a consumer device C(c) 102, where c can be a value from 1 to C. For example, the consumer device C(c) 102 can be a computer, a server, cellular phone, personal digital assistant (PDA), a kiosk located in a retail establishment such as a shopping mall, a pager, a scanner connected to a network, a wireless terminal, or a combination thereof. The consumer device C(c) 102 transmits a first transmission to a Requested Offer Supplier (ROS) 104 through a ROS-C network 120. The ROS 104 may have an automatic call handler configured to receive and send transmissions to the consumer device C(c) 102 and a server linked to a storage S(s) 108 through a ROS-S network 140.

The ROS 104 may receive multiple transmissions from a plurality of consumer devices C(c) 102. The transmission may include the request for inventory from the consumer device C(c) 102, such as a good or service, that the consumer may be interested in purchasing, hiring, leasing, licensing, or gaining the benefit of. The requested inventory may be, for example, a description of a good or service, such as “red high heel shoes”; the make and/or model of a good or service such as “Apple iPod Nano® music player”; a category for a good or service such as “Barber”; a unique inventory identifier such as Stock Keeping Unit (SKU), a Universal Product Code (UPC) or International Standard Book Number (ISBN); a description of a manufacturer such as “mp3 player manufacturer”; a description of the function of a good or service such as “equipment for painting a house”; or an optically scanned image associated with the requested inventory such as a picture of a book, an infrared scan of the SKU, an International Standard Book Number (ISBN), a Universal Product Code (UPC), or bar code, for example.

The request for the inventory may take different forms. The consumer may enter text in a query box, choose from a pull down menu having inventory categories, enter a voice recording describing the request for inventory, pick through hyperlinked web pages describing inventory of the merchants' M(m) 106, or choose from thumbnail pictures of the merchants' M(m) 106 inventory. Other forms of data entry that are well known in the art may also be used. The consumer may have to download or upload software to the consumer device C(c) 102 to enable the described transmission forms.

The transmission from the consumer device C(c) 102 may include a unique identifier for the consumer, such as an account number associated with the automated communication system, the account number of the account in the payment processing system, a social security number, a consumer name, or a consumer code.

Moreover, the transmission from the consumer device C(c) 102 may include a return address. The return address may be the address of the consumer device C(c) 102 or the address of a different consumer device C(c−1) 102. For example, the consumer device C(c) 102 may be a desktop computer that sends out the first transmission but the transmission may have a phone number to a wireless telephone as the return address. The return addresses may include, for example: a cellular telephone number/address, an Internet Protocol (IP) address, a street address, an email address, a password, an identification code, a code associated with the account in the payment processing system such as an account number, a routing number, or combinations thereof, for example.

The transmission from the consumer device C(c) 102 may include the location of the consumer. The location can be the real time location of the consumer based on, for example, the real time location (e.g., present location) of the consumer device C(c) 102. The consumer device C(c) 102 may also have a position detector, such as global positioning system, that can determine the real time location of the consumer device C(c) 102 including the street address of the consumer device C(c) 102, the latitude and longitude of the consumer device C(c) 102, the World Geodetic System coordinates of the consumer device C(c) 102, or combinations thereof. By way of example from the foregoing, the transmission from the consumer device C(c) 102 through the ROS-C network 120 may include the requested inventory, the unique consumer identifier, and a return address that may be the real time location of the consumer device C(c) 102.

The transmission from the consumer device C(c) 102 may take different forms. The transmission may be a Short Message Service (SMS) transmission, a voice transmission, or a data transmission such as a data transmission over the Internet. For example, the consumer device C(c) 102 may have an Internet browser that can connect to a server associated with the ROS 104.

The consumer may have to enter a user identification and password to access the account with the ROS 104. The account with the ROS 104 may be specific to the consumer device C(c) 102 such that access is limited solely through use of the consumer device C(c) 102, or access may be specific to the consumer such that the consumer may access the account with the ROS 104 through a plurality of the consumer devices C(c) 102.

As seen in FIG. 1, each merchant is represented a reference numeral M(m) 106, where m can have a value from 1 through M. The merchant M(m) 106 may be a retail store that has inventory at the merchant M(m) 106 location when the merchant M(m) 106 offers the offer. Alternatively, the merchant M(m) 106 may have a warehouse that is at a different location from the merchant M(m) 106 retail store or the merchant M(m) 106 may be a franchisee with access to inventory located at other franchisee stores. The inventory may be a new item that has not yet arrived into the market, or the inventory may be a service such an oil change for an automobile, a house cleaning service, or a mobile service such as a taxi cab service. The merchant M(m) 106 inventory includes both stock in present possession or inventory that can be obtained within a predetermined time period.

The ROS 104 may be in communication with the plurality of the merchant M(m) 106 through an ROS-M network 130. For example, the ROS 104 may transmit a transmission to the merchant M(m) 106 via the ROS-M network 130, where the transmission to the merchant M(m) 106 can includes information from the storage S(s) 108 such as the requested inventory from the consumer with the consumer device C(c) 102, the consumer unique identifier, information corresponding to the account in the payment processing system such as purchases made on the account in the payment processing system that match the requested inventory, an indication of the location of the consumer, a return address, or a combination thereof. The merchant M(m) 106 may also transmit transmissions to the ROS 104. For example, the merchant M(m) 106 may transmit to the ROS 104 a list of its inventory via ROS-M network 130. Alternatively, the merchant M(m) 106 may send a transaction message transmission to the ROS 104 that a transaction occurred at the merchant's M(m) 106 location that applied the offer sent by the ROS 108 to the consumer device C(c) 102 from the merchant M(m) 106.

The merchant M(m) 106 may be associated with a merchant processing system. The merchant processing system may be an in-house computer that communicates with the ROS 104 via the ROS-M network 130. For example, a franchisor may manage each of the merchants M(m) 106 that are within the franchisor's franchisees. The franchisor, as the merchant processing system, may be in communication with the ROS 104. When the franchisor receives a processing system transmission including the consumer requested inventory and the location of the consumer, it determines the location of matching inventory and either has the merchant M(m) 106 franchisee make the offer or the franchisor may make the offer directly to the ROS 104 that the ROS 104 then communicates to the consumer device C(c) 102 of the consumer. Alternatively, the merchant processing system may be a third party with a contractual arrangement with the merchant M(m) 106, linking the ROS 104 with the merchant M(m) 106. For example, the merchant processing system may be part of a mall management that overlooks leasing, marketing, maintenance of common area, security of common area and operational activities with each of the merchants M(m) 106, the consumers of each of the merchants M(m) 106, or the suppliers of each of the merchants M(m) 106. The mall management may receive a processing system transmission including information such as the requested inventory, a indication of the transaction history of purchases made on the account in the payment processing system, a return address, an indication of the location of the consumer device C(c) 102 transmitting the first transmission such as the consumer's proximate location within the mall, a location of a competitor location, a location of a home address of a consumer associated with the consumer device C(c) 102, or a combination thereof. The mall management may then send to the ROS 104 a second processing system transmission including a set of matching merchants, that is a plurality of the merchant M(m) 106, offering an offer for the requested inventory and their respective offers. The set may be a subset of the ROS' 104 set of matching merchants offering an offer for the requested inventory.

In yet another example, the merchant processing system may be a dispatching unit for taxi cab drivers. The consumer may use the consumer device C(c) 102 to submit a request for a taxi ride service for departure to a destination. The merchant processing system may locate a taxi closest to the consumer device C(c) 102, give an offer for the ride from the location of the consumer device C(c) 102 to the destination, and dispatch the closest taxi upon receiving a return processing system transmission that the consumer accepts the offer. In another example, the merchant processing system may locate a taxi service the that the consumer with the account in the payment processing system has used in the past; the payment processing system may transmit the taxi service's offer via a merchant processing system transmission to the consumer.

Storage is represented in FIG. 1 at reference numeral the storage S(s) 108, where the value of s can be from 1 to S. As such, each of the storage S(s) 108 can be one or more storage devices which may each include data, such as information about a plurality of the merchant M(m) 106. For example, the data may include a name for each of the merchants M(m) 106, a location for the merchant M(m) 106, a location for the inventory, a location of each of a plurality of competitors of each of the merchants M(m) 106, a list of the goods and/or services in the inventory of each of the merchants M(m) 106, or a combination thereof. The merchant M(m) 106 may update data in the storage S(s) 108 with information regarding the inventory of the merchant M(m) 106, such as a description of the inventory of the merchant M(m) 106. For example, the merchant M(m) 106 may have an account with the ROS 104. The merchant M(m) 106 may log on to its account with the ROS 104 and update its inventory list in the storage S(s) 108 at predetermined time periods such as every week. In another example, the merchant M(m) 106 may have part of the storage S(s) 108 in communication with an inventory maintenance system of the merchant M(m) 106, such as an accounting system for the merchant M(m) 106 that may update automatically the data in the storage S(s) 108. The merchant M(m) 106 may add or delete portions of the information regarding the inventory within the storage S(s) 108, such as deleting the portion of the information regarding the inventory when the inventory is no longer available for offers. The merchant M(m) 106 may instruct the ROS 104 not to transmit the offer to the consumer's requesting the inventory even if the consumer is within the predetermined distance. Alternatively, the instructions to the ROS 104 may indicate that if the offer has already been made to a consumer but the consumer has not yet accepted the offer (e.g., redeemed the offer), the ROS 104 can transmit a revocation of the offer to the consumer.

The data in the storage S(s) 108 may also include information regarding the consumer with the consumer device C(c) 102. For example, the storage S(s) 108 may include: the inventory requested by a consumer using the consumer device C(c) 102, the location of the consumer device C(c) 102, the unique identifier for the consumer corresponding to the consumer device C(c) 102, the home address of the consumer corresponding to the consumer device C(c) 102, a previous the consumer device C(c) 102 location, or a previous request for inventory from the consumer corresponding to the consumer device C(c) 102 and corresponding merchant offers. Moreover, the data may include information regarding the account in the payment processing system such as: purchases made on the account in the payment processing system, inventory purchased using the account in the payment processing system, transactions to which offers of the merchant M(m) 106 have been applied to in the past, the merchant's M(m) 106 offers in the past, or a combination thereof. The storage S (s) 108 can be a database, such as a relational database, that is located within the ROS 104. Alternatively, each of the storage S(s) 108 can be in a different geographic location such that storage S(1) 108 is at a different geographical location than storage (2) 108.

Each of the storages S(s) 108 may be associated with computer code that, when executed, can match the requested inventory received from the consumer device C(c) 102 with a set of merchants (m) 106 who are willing to make at least one offer for their respective inventories that corresponds to the inventory that was requested by the consumer.

In order to be part of the system 100, the entities will preferably first enroll into the system 100. For example, the consumer may first have to enroll by opening an account with the ROS 104. The account with the ROS 104 may be specific to the consumer device C(c) 102 corresponding to the consumer, in which access to the account with the ROS 104 is limited to uses of the consumer device C(c) 102, or it may be consumer specific through the use of a consumer unique identifier. The consumer may set up a profile within the account with the ROS 104. For example, the consumer may enter information regarding the consumer's home address into the storage S(s) 108 and request that the consumer device C(c) 102 receive any offers for a new release of specific DVDs that are sold near the consumer's home address.

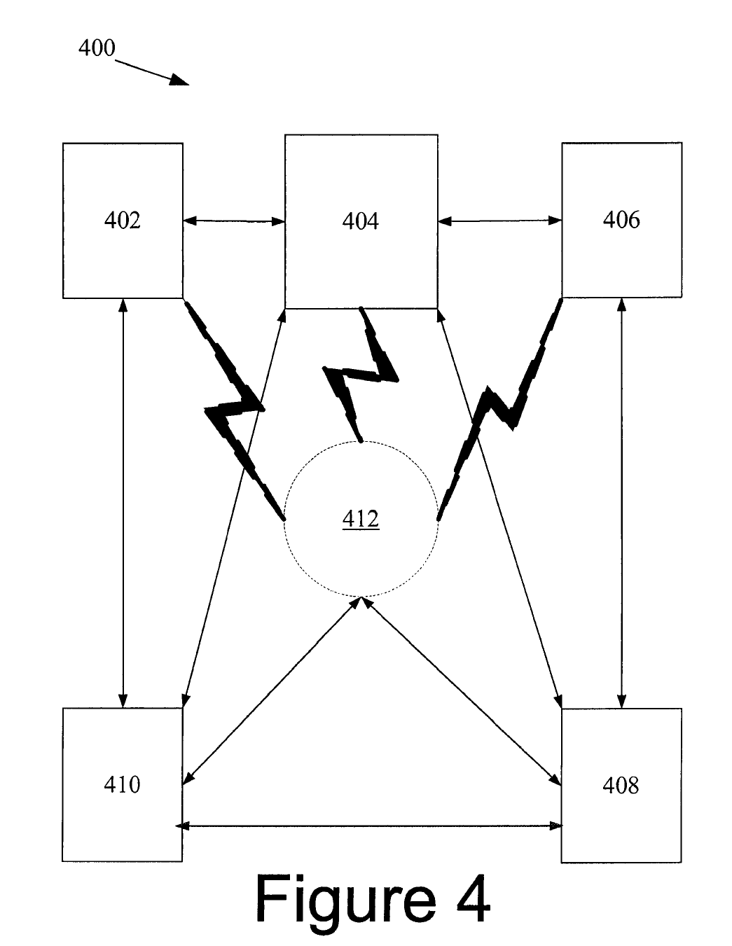

The consumer may also enter the consumer's credit card information into the account with the ROS 104. For example, the consumer may enter credit card information for the consumer's gold card corresponding to a particular payment processing system as described below relative to FIG. 4. The merchant M(m) 106 may give different offers to gold card members that the merchant M(m) 106 would not otherwise have offered, such as 10% off luxury items including non-costume jewelry.

Each of the merchants M(m) 106 may also enroll in order to be part of the system 100, and will involve itself in setting up a corresponding merchant profile. For example, the merchant M(m) 106 may set up a merchant profile indicating the location of each of the merchants' M(m) 106 franchisees and their respective inventories.

The merchant M(m) 106 may give the ROS 104 business rules that delineate conditions and parameters for the offer. The conditions for the offer can include requirements for the offer that must be satisfied prior to the offer being given to the consumer, such as: the consumer using a particular brand of credit card be used to redeem the offer or the consumer being within the predetermined distance. For example, once it is determined that the consumer is within the predetermined distance, the ROS 104 may generate and transmit an offer stating “if you use your Wells Fargo® credit card at Neiman Marcus located on 5th street you will get 10% off the pair of red shoes you requested.”

The merchant M(m) 106 may give the ROS 104 business rules with a condition on providing a second offer to the consumer. The ROS 104 may transmit the second offer can when the consumer has already received a first offer and has entered a second predetermined distance from the merchant M(m) 106. For example, the consumer may have requested an offer for an Italian dinner for two, once the consumer is within the predetermined distance of one mile from the merchant's M(m) 106 dining facility, the ROS 104 may send the consumer an offer for a $20 U.S. credit back that will be applied to the account in the payment processing system associated with the consumer as delineated by the business rule for the offer. The consumer may decide to go elsewhere, despite the $20 U.S. credit back offer, and walk away from the merchant's M(m) 106 dining facility, moving past the predetermined distance of one mile from the merchant M(m) 106 to one mile and ten yards. The ROS 104 may send a second offer to the consumer that received the first offer; the second offer may be for a $30 U.S. credit back that will be applied to the account in the payment processing system associated with the consumer as delineated by the business rule for the second offer.

Another example of one of the conditions for the offer may be the duration of time the consumer is within the predetermined distance. For example, the business rule may denote that the consumer must be within the predetermined distance for at least one minute prior to the ROS 104 transmitting the offer to the consumer. Consequently, the offers are not transmitted to consumers that may be traveling past the merchant's M(m) 106 facility under the one minute threshold, such as driving by a mall. In this manner, the cost to the merchant M(m) 106 for making the offers may be reduced, such as when the merchant M(m) 106 pays the ROS 104 on a per transmitted offer basis. Moreover, nuisance type marketing to the consumer may be reduce because the consumers that are just passing through the predetermined distance are not sent an offer.

The condition may also denote a quality of the offer itself. For example, the offer is only valid when redeemed within a window of time such that the offer is irrevocable before the passage of that window of time. To illustrate, an offer may expire three (3) hours after the consumer receives the offer via that consumer's corresponding the consumer device C(c) 102 over the ROS-C network 120. The start time for the window need not begin with the receipt of the offer by the consumer device C(c) 102. For example, the merchant M(m) 106 may know that it has a shipment of Microsoft® Xbox® products corning in two (2) weeks. The merchant M(m) 106 may update the merchant's M(m) 106 inventory information in the storage S(s) 108 and indicate that an offer for the Xbox® products be with the condition that the inventory will be available to the consumer requesting the Xbox® products at a time period between 2 weeks to 3 weeks from the date of the merchant M(m) 106 updating the inventory information. In another example, the merchant M(m) 106 may be a restaurant. The merchant can make the offer valid for date and a time period such as Dec. 24, 2007 from 4:00 p.m. to 8:00 p.m.

The parameters for the offer may include a transaction history of the account in the payment processing system, a characteristic of the account in the payment processing system, the distance between the consumer and the merchant M(m) 106, a competitor distance between the consumer and a competitor of the merchant M(m) 106, a quantity of the inventory that the merchant M(m) 106 may have in-stock, or a combination of the foregoing.

One of the parameters for the offer may include a trend within the transaction history of the account. The transaction history may be purchases made on the account in the payment processing system between the consumer associated with the account and any merchant. For example, the business rule for the offer may delineate that the merchant M(m) 106 will make a “$10 U.S. cash back” offer to those of the consumers that have shown a trend of buying fall apparel in the past. An analysis of purchases made on the account in the payment processing system of the consumer may reveal that the account in the payment processing system has been used to make apparel purchases at the beginning of each fall, specifically, new children's pants have been bought each year in the month of September. Consequently, the ROS 104 will send the “$10 U.S. cash back” offer for the fall apparel requested by the consumer that is within the predetermined distance from the merchant M(m) 106. In another example, the analysis may reveal that the account in the payment processing system has recently been used to purchase bed sheets but not comforters. The trend with the transaction history of the account may reveal that the consumer typically purchases matching comforters with the purchase of sheets. The merchant M(m) 106 may have a parameter within the merchant's M(m) 106 business rules for the offer that if the consumer requesting an inventory item shows a trend in purchasing related inventory items with the requested inventory item, to make an offer for the related inventory item.

The analysis may further determine the probability that the account in the payment processing system can be used to make a further purchase given the past purchasing trends. For example, given the account in the payment processing system's past activity in the Digital Video Disc (DVD) market, an analysis may revealed a trend that the consumer typically purchases new DVD releases in the genre of drama; the analysis may further yield a high probability that the consumer with that account in the payment processing system may be interested in purchasing a newly released drama or, as in the earlier example, there is a significant probability that the consumer with that account in the payment processing system may be interested in purchasing a comforter. Any conventional or predetermined algorithm for data analysis may be used to determine trends within the data of purchases on the account in the payment processing system. For example, data mining analysis such as Market Basket Analysis, a pattern recognition analysis, optimization analysis, statistical analysis, a data mining analysis, algorithm demographic analysis, classification analysis, or segmentation analysis can be used. To illustrate, a customer who has purchased lawn care items in April for the last four years might be identified as being highly likely to purchase lawn care items this April. In another example, general consumer trends may be analyzed to determine highly correlative events, such as “consumers who purchased shoes also buy socks within 90 days of a shoe purchase.” In another example, consumer purchase behavior trends may be analyzed to reveal consumers which spend a relatively large sum in restaurants, and/or tend to spend significantly larger amounts in restaurants than average restaurant patrons. Consequently, the business rules for the offer may base the value of the offer on such trends within the transaction history of the account.

Other parameters that the offer may be based on include: a second offer for the inventory from the competitor of the merchant (e.g., the consumer states that the consumer has received a competing offer from the competitor of the merchant M(m) 106 and requests that the merchant M(m) 106 make another offer); a sales volume of the competitor of the merchant for the inventory as determined by transactions for the inventory between the competitor of the merchant and a plurality of consumers having a plurality of corresponding accounts within the payment processing system wherein the transactions were each payable on the corresponding accounts (e.g., the ROS 104 or the transaction hander, for example, may have transaction history of the competitor of the merchant in the storage S(s) 108 that can be analyzed to determine the sales volume for the inventory, such as when the SKU numbers are also stored in the storage S(s) 108, this information can be used to determine the value of the offer of the merchant M(m) 106); a time that the consumer is within the predetermined distance (e.g., during Christmas, during off hours such as 3:00 p.m. in the mall), the quantity of the inventory that the consumer has requested (e.g., the offer may be 10% off for 15 pairs of shoes but 5% off for two pairs of shoes); a duration of time that the inventory has been in the possession of the merchant (e.g., the inventory of the merchant M(m) 106 that has not been sold in the last month may have a greater percentage off offer than one that has just arrived into the possession of the merchant M(m) 106); the location of the inventory (whether the inventory is at a franchisor's store in the mall or at a intersection with little traffic, whether the inventory is located at the door of the store where other items may be of interest to the consumer or at the back of the store).

The purchase made on the account in the payment processing system may be stored in a database such as the storage S(s) 108. Therefore, if the ROS 104 receives a transmission with a request for a newly released DVD drama, for example, the ROS 104 may retrieve from the storage S(s) 108 each purchase made on that account in the payment processing system that matches the requested inventory of newly released drama DVDs. The ROS 104 may conduct an analysis on the matches made on the account in the payment processing system to the requested inventory to determine the probability of a future purchase of similar inventory and relay the information to the merchant M(m) 106. The merchant M(m) 106 may then use the past purchase trend, such as DVD purchases, to determine what kind of offer to provide the consumer with the account in the payment processing system in order to entice the consumer to make the purchase of the inventory with the merchant M(m) 106. For example, the merchant M(m) 106 may provide an offer of 10% off for a newly released drama DVD when the consumer is detected as being within the predetermined distance.

Another example of the parameter may be the characteristic of the account in the payment processing system. For example, the transaction handler or the issuer of the account in the payment processing system may have categorized the account in the payment processing system as a “gold card account” such that a holder of the account in the payment processing system (e.g., the consumer) may receive special loyalty program benefits or services. Such categories may be based on the income level of the holder of the account in the payment processing system, a credit rating of the holder of the account in the payment processing system, or the transaction history of the account in the payment processing system. The merchant M(m) 106 may want to target the merchant's M(m) 106 offers to such categorized consumers. Consequently, one of the business rules may require that the consumer be a “gold card account” holder. To illustrate, a Tiffany & Co.® jewelry store may have a business rule that an offer based on the condition that the consumer be within 1 mile of the Tiffany & Co.® jewelry store. Moreover, the Tiffany & Co.® jewelry store may have a business rule that bases the value of the offer based on the parameter that the consumer be a gold card account holder. When the consumer with a gold card account comes within 1 mile of a Tiffany & Co.® jewelry store, the consumer may receive from the ROS 104 an offer stating “Tiffany & Co.® will honor your request for an 18 carat diamond ring and will take 5% off of your total invoice if you also purchase the matching earrings using your Tiffany & Co.® credit card.”

Yet another example of one of the parameters for the offer may be a distance between the return address, such as the location of the consumer device C(c) 102, and that of the merchant's M(m) 106 inventory or Point of Service (POS) terminal. For example, the offer value may be a function of the distance between the consumer C(c) 102 and the merchant M(m) 106 such as a motorized route distance between the location of the consumer C(c) 102 and the location of the POS of the merchant M(m) 106. Other means for determining the value of the distance may be the straight line distance between the consumer C(c) 102 and the merchant M(m) 106, a non-motorized route distance; a distance which can be covered within a predetermined time period using a motorized vehicle; a distance which can be covered within a predetermined time period using a non-motorized vehicle; a distance which can be covered within a predetermined time period by walking; and a combination thereof.

To illustrate, if the consumer device C(c) 102 is within 5 miles of the inventory, the merchant M(m) 106 may offer a two-for-one offer, while if the consumer device C(c) 102 is within five minutes walking distance from the inventory, the merchant M(m) 106 may offer a 15% off offer. Therefore, the merchant M(m) 106 may tailor the offer to the offeree's location. The tailoring can be based on the merchant M(m) 106 assessment of what kind of offer may be best to entice the particular consumer to make the effort to travel the distance to the point of service and to conduct a transaction involving the request inventory, such as purchasing the requested good or received the requested service.

The offer may be a function of a parameter for the offer that is the competitor's distance. The competitor's distance may be equal to a distance between the consumer device C(c) 102 and competitors of each of the merchants M(m) 106. For example, Niemen Marcus may offer 15% off shoes to the customer making a request for shoes via the consumer device C(c) 102 in a transmission that indicates that the consumer device C(c) 102 is located within five (5) minutes walking distance from Niemen Marcus' competitor, a Saks Fifth Avenue® retail store.

The business rules may be translated into computer code that, when executed, can algorithmically calculate the offer in an automated fashion without having to contact personnel at the merchant's M(m) 106 location for each consumer requested inventory. The calculation can be based on an algorithm that follows the business rules for the offer.

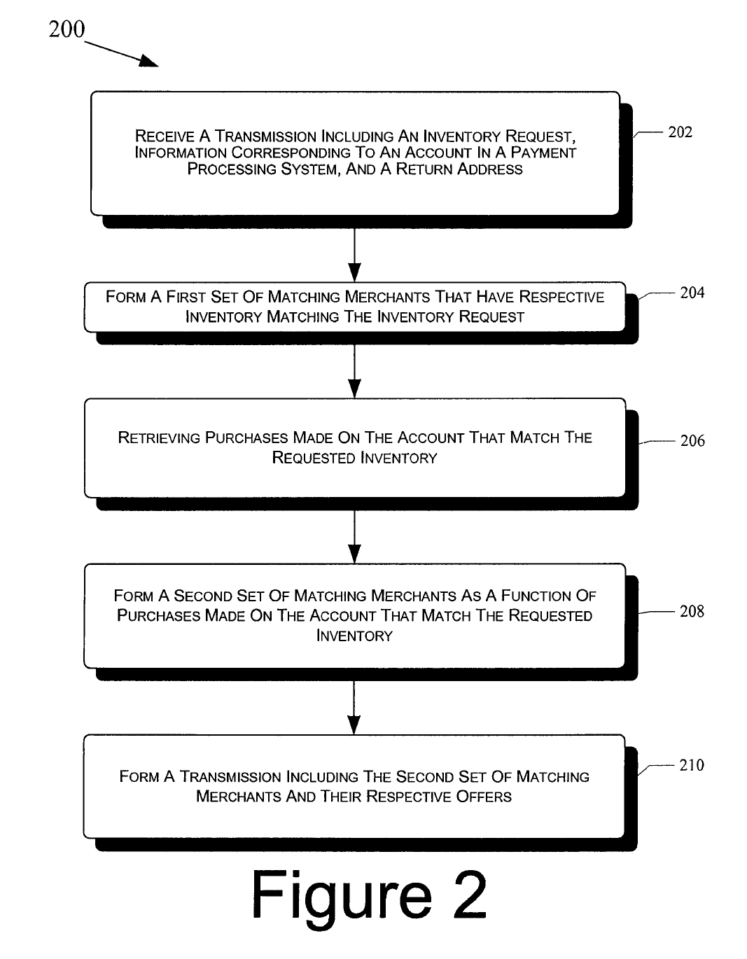

Referring to FIG. 2, a flow chart is used to illustrate an exemplary process 200 for supplying an offer incident to a consumer request for inventory, where an algorithm is used to derive the offer. The algorithm may base a value of the offer, at least in part, on the predetermined distance parameter or transaction history of the account in the payment processing system such as information about past purchases made payable on the account in the payment processing system associated with the consumer.

Process 200 begins at step 202 where a transmission is received. The transmission may include a requested inventory, information corresponding to the account in the payment processing system, the location of the consumer device C(c) 102, and/or the return address. The requested inventory may be a request for any good or service. The information corresponding to the account in the payment processing system may be an Internet Protocol address, an identification code, a password, a cellular phone number, an account number, a routing number, a billing address, or a combination thereof. For example, a cellular phone number may be stored in the storage S(s) 108 and associated with the account in the payment processing system. Once the cellular phone number is received, the account number can be retrieved from the storage S(s) 108. As stated previously, the return addresses may include, for example: a wireless telephone number/address, an IP address, a street address, an email address, an identification code, a code associated with the account in the payment processing system, or combinations thereof.

For example, a consumer may request a book by its title using a PDA communicatively connected to the ROS 104. The PDA may have a GPS that also transmits the location of the PDA to the ROS 104. The transmission may have a unique code for the PDA that the ROS 104 can use to send a transmission back to the PDA. Moreover, the ROS 104 may use the unique code for the PDA to determine the account in the payment processing system. For example, the storage S(s) 108 may have information on the account in the payment processing system associated with the unique code for the PDA. Once the ROS 104 receives the unique code for the PDA, it may retrieve information on the account in the payment processing system. In this manner, the unique code for the PDA can serve two purposes: the return address and the information corresponding to the account in the payment processing system.

At step 204, a first set of matching merchants is formed using the storage S(s) 108 to signify that they have the consumer requested inventory. The storage S(s) 108 may have a first database in communication with the ROS 104 from which the first set of matching merchants M(m) 106 is formed. Matching consumer requested inventory to the inventory of the merchants M(m) 106 may be done in a number of ways. For example, the merchant M(m) 106 may register certain keywords to be used in matching, such as “hardware” or “chain saw” or “Black and Decker®.” In another example, the merchant M(m) 106 may have a categorization code registered with the server, such as a Merchant Category Code, Standard Industrial Classification (SIC) Code, or IRS Business Activity Code. In another example, the merchant's M(m) 106 address may be registered and utilized in conjunction with other registered or known attributes of the merchant M(m) 106 or keywords in order to determine the merchant's M(m) 106 eligibility to be considered as an offeror.

The matching process may occur through a series of inventory category matches. For example, the merchant M(m) 106 may have inventory that is classified according to a predetermined inventory classification system into inventory categories such as apparel, hardware, or home furnishing. The classification system may have sub-categories such as women's comfort shoes, CRAFTSMAN® 3/16×4 in. screwdrivers, or inner spring mattresses. The requested inventory received via the first transmission may be put into at least one inventory category according to the predetermined inventory classification system. The matching of the requested inventory to each of the merchants' M(m) 106 inventory can occur such as by identifying those the merchant M(m) 106 that have inventory in at least one inventory category that the requested inventory is classified into. For example, the consumer may request “blue high heeled shoes” that can be classified into each of the following categories: shoes, women's shoes, blue shoes, and Salvatore Ferragamo® shoes. These categories may have the subclass of “high heel.” Therefore, the category, including the subclasses thereof, for the requested inventory is compared against the category of the merchant's M(m) 106 inventory until each match is found. As matches are found, the first set of matching merchants is accumulated and formed. Other methods of matching are well known in the art and are contemplated for implementations with the present invention.

The set of merchants' (m) 106 respective offers may comprises an inventory list that match the received requested inventory. For example, if the requested inventory is for bedding, the merchants' (m) 106 offer may include a list of offers for bedding, matching curtains, matching towels, and bedroom furniture. Consequently, the inventory of the merchant M(m) 106 may match the requested inventory when both the inventory of the merchant M(m) 106 and the requested inventory are the same, when the inventory of the merchant M(m) 106 and the requested inventory are typically used in conjunction with one another (e.g., shoes and socks), or when the inventory of the merchant M(m) 106 and the requested inventory complement each other (e.g., shower curtain and towels having a the same thematic print).

The ROS 104 may query the consumer device C(c) 102 through successive transmissions until the correct categories are obtained in order to perform a match. The consumer device C(c) 102 may have an interface such that requested inventory can be entered using a series of categories from the predetermined classification system, for instance by use of the consumer device C(c) 102 having a user interface with an interactive pull down menu showing a branching of the classification system and from which a request for inventory is made by the consumer.

At step 206, a second set of matching merchants is formed from the first set of matching merchants. The respective algorithms for deriving the offer of each of the merchants M(m) 106 is used to determine at least the value of each of the merchant's M(m) 106 offer.

As stated previously, the value of the offer may be a function of the predetermined distance between the location of the consumer device C(c) 102 and that of each the merchant M(m) 106. The location of the consumer may be compared to the location of each of the merchants M(m) 106 and a distance of the consumer relative to the merchant M(m) 106 can be calculated. The calculated distance is then compared to the predetermined distance to determine if the consumer qualifies for the offer by being within the predetermined distance from the merchant M(m) 106. The storage S(s) 108 may have a second database in communication with the ROS 104 from which the second set of matching the merchant M(m) 106 is formed. The second database may comprise of the first set of matching the merchant M(m) 106 found in step 204.

The offer may be derived from the transaction history of the account associated with the consumer using the consumer device C(c) 102. The storage S(s) 108 may contain the past transaction history of the consumer that the ROS 104 may either relay to the merchant M(m) 106, or the ROS 104 may analyze the transaction history of the consumer corresponding to the requesting the consumer device C(c) 102 to determine trends and buying habits of the consumer. For example, the consumer may have asked for blue shoes in a transmission from the consumer device C(c) 102 sent to the ROS 104 in the past. The storage S(s) 108 contains logged information of the transmissions to and from the ROS 104 such as in a transmission database.

Alternatively, or in combination, the value of the offer may be based on purchases made on the account in the payment processing system that match the requested inventory. For example, the ROS 104 may access the storage S(s) 108 to determine what purchases have been made on the account in the payment processing system in the past. Those purchases that match the requested inventory may be filtered out of the full set of purchases that exist for the account in the payment processing system. For example, the consumer may have asked for blue running shoes. The information with the storage S(s) 108 may indicate that the account in the payment processing system has been used to purchase blue running shoes in the past and that typically white socks are bought within a short period thereafter. Moreover, the transaction history of the account in the payment processing system also shows that the account in the payment processing system is also frequently used to purchase sports drinks on Sundays. This information, the shoes, the socks, and the sports drink, may be used singularly, or in combination as input to an algorithm to determine as “matches” for the requested inventory that are retrieved.

Once filtered, data analysis can be done to produce an output that can assist the merchant M(m) 106 make a decision as to what offer to make to the consumer with the account in the payment processing system such as a characterization of the transaction history of purchases made on the account in the payment processing system. For example, based on the transaction history of the account in the payment processing system, a probability curve can be determined indicating how probable it would be for the consumer with the account in the payment processing system to purchase running shoes, socks, and/or sports drinks in the future. Alternatively, or in combination, the outcome of the analysis need not be a probability; rather, it can be a statement such as “this consumer typically buys white socks with blue tennis shoes.”

The ROS 104 may send a merchant transmission to the merchant M(m) 106 including the requested inventory and a characterization of the transaction history of purchases made on the account in the payment processing system in order to determine if the merchant M(m) 106 is making an offer. The ROS 108 may then accumulate all matched of the merchants M(m) 106 that are making offers so as to form the second set of matching merchants. The storage S(s) 108 may have a second database in communication with the ROS 104 from which the second set of matching merchants is formed. As in the case where the offer is based on the parameter of the consumer being within the predetermined distance, the second database may comprise of the first set of matching merchants found in step 204.

The ROS 104 may then form a merchant transmission addressed to the each of the merchant M(m) 106 in the second set of matching merchants, the transmission including the requested inventory and the characterization of the transaction history of purchases made on the account in the payment processing system. The ROS 104 may then receive a second merchant transmission including at least one offer from at least one merchant M(m) 106 in the second set of matching merchants and forward the offer and the corresponding merchant M(m) 106 making the offer to the consumer via the return address. For example, the consumer may request motor oil, the ROS 104 may form the second set of matching merchants having motor oil in their respective inventories and have indicated to the ROS 104 that they are willing to make offers to consumers requesting motor oil. The ROS 104 may make phone calls to each of the merchants M(m) 106 in the second set of matching merchants indicating that there is a consumer requesting motor oil, the consumer is within the merchant's M(m) 106 indicated predetermined distance, and that the consumer has purchased motor oil every six months for the past two years. Merchant M(1) 106 and merchant M(2) 106 may indicate that they want to make an offer of 10% off a quart of motor oil to the consumer. The ROS 104 may send a transmission to the consumer via the return address indicating the names of the merchant M(1) 106 and the merchant M(2) 106 and their respective offers of ten percent (10%) off. The offer may be based on the consumer's past purchases of motor oil.

Alternatively or in combination, the ROS 104 may have a predetermined algorithmic rule to calculate an offer for M(m) 106. For example, the predetermine algorithm may use a Basket Market Analysis. Given the antecedent of the requested inventory (e.g., shoes) in a Basket Market Analysis, if the support for the consequence (e.g., socks) is an eighty-five percent (85%) probability, then the offer of ten percent (10%) off the regular price for the consequence (e.g. socks) may be created automatically.

The ROS 104 may also track the consumer's transmissions or transactions applying an offer to which the consumer may have been a party in the past. The ROS 104 may use the tracked transmissions and/or transactions to rate the consumer's propensity to ask for offers or to apply offers that the ROS 108 may relay to the merchant M(m) 106 for the merchant's M(m) 106 use in deriving the value of an offer. Moreover, the value of the offer may be derived using information about the consumer's transaction history independent of whether the consumer had in the past made application to obtain an offer for those past transactions in the consumer's transaction history.

At step 210, a transmission, such as a second consumer device transmission, addressed to the return address is formed. The transmission may have the second set of matching merchants, their respective locations, and their respective in-person offers. At step 210, a second transmission is formed, where the second transmission has the second set of matching merchants, their respective offers, and/or a location of a point of service of the merchant at which the requested inventory may be purchased. The second transmission can be addressed to the return address. The return address may be the address of the consumer device C(c) 102 that sent the first transmission or it may be from a different the consumer device C(c−1) 102. For example, the consumer device C(c) 102 may have an interface wherein the names of the second set of matching merchants is presented, each name linking to the respective merchant's M(m) 106 location or offer.

The second transmission may also have a narrative conveying information about the requested item or the inventory of the second set of matching merchants. For example, the consumer may have requested an offer for a child car seat. The second transmission may include the second set of matching merchants having offers for the child car seat and include the Consumer Reports® rating for each child car seat listed in the second set of matching merchants. Other examples of narratives include: other consumers' ratings of the requested inventory obtained from a plurality of the consumer device C(c) 102, recent news articles about the inventory being requested, alternative inventory that can be requested such as suggested related inventory for use with the requested item of inventory (e.g.; a suggestion of socks appropriate for consumer requested shoes), and advertisements such as promotional materials for “red shoes” when the requested inventory was “blue shoes.”

The steps 202-210 can occur over a short period of time. The first transmission and the second transmission may occur consecutively over a period of seconds to minutes, such as about 5 minutes, thus approaching a typical impulse purchase decision time period corresponding to the type of inventory being requested by a consumer.

An offer from the merchant M(m) 106 may have a corresponding confirmation code. The confirmation code may be an alphanumeric code, a word, a picture, a text and figure combination, an encrypted message, or a combination thereof. The confirmation code may be included in the second transmission, the merchant transmission addressed to the merchant M(m) 106, or to a combination thereof. When the consumer wishes to apply the offer for a transaction at the merchant's M(m) 106 location, the consumer may present the confirmation code to the merchant M(m) 106. The presentation can occur visually, such as when the consumer displays the confirmation code received by the consumer device C(c) 102 to the merchant M(m) 106 (e.g.; a cellular telephone text message is shown to the merchant's operator of an Acceptance Point Device or Point-Of-Service (POS) terminal), verbally such as when the consumer states an alphanumeric sequence or the word representing the confirmation code, or electronically such the consumer entering the confirmation code into a Point of Service (POS) terminal at the merchant's M(m) 106 location. The merchant M(m) 106 may have a copy of the confirmation code that has been received via the merchant transmission or otherwise via access to the storage S(s) 108 via the ROS 104 so as to validate the consumer's confirmation code that the consumer presents to the merchant M(m) 106. For example, the merchant M(m) 106 may visually check an alphanumeric code against an alphanumeric code that the merchant M(m) 106 has received from the ROS 104 for the offer addressing the inventory requested by the consumer.

The merchant may transmit a confirmation transmission to the ROS 104 including data that confirms that the confirmation code included in the second transmission was matched with the confirmation code included in the merchant transmission. For example, the confirmation transmission may include the matched confirmation code, the location of the merchant M(m) 106 where the confirmation code was matched, an indication that the matched confirmation code corresponds to a transaction for the corresponding offer, a date on which the transaction took place, a sub-total of a financial transaction involving only the consumer requested inventory, or the total amount of a financial transaction by the consumer with the merchant M(m) 106 which included other items besides the consumer requested inventory.

Alternatively, or in combination, the merchant M(m) 106 may run the consumer's credit card through a POS terminal that is part of the payment processing system that is communication with the ROS 108. The ROS 104 may be part of the payment processing system.

The ROS 104 may be a transaction handler within the payment processing system associated with the account in the payment processing system, such as a credit card company that validates the confirmation code. The transaction handler may have transmitted the confirmation code to the merchant M(m) 106 and to the consumer after the transaction involving the confirmation code has occurred between the merchant M(m) 106 and the consumer. The merchant M(m) 106 may transmit a transaction message to the transaction handler for the transaction involving the confirmation code may include the confirmation code. The transaction handler may validate the confirmation code within the payment processing system such as by checking the confirmation code sent to the consumer against the received transaction message from the merchant M(m) 106. For example, the consumer may use a credit card recognized in a payment processing system to purchase a diamond ring while applying the offer the consumer received for the diamond ring from the merchant M(m) 106 via the transaction handler. The merchant's M(m) 106 POS terminal may transmit the transaction message to the transaction handler which is the ROS 104 in communication with the payment processing system. The transaction message may include payment information, the value of the offer, and the confirmation code. The transaction handler can then validate the confirmation code during an authentication phase, for example, of the transaction by checking the confirmation code received from the merchant M(m) 106 against what was sent to the consumer. If the offer-confirmation is not matched, the transaction is rejected and the offer is not applied toward the purchase.

The ROS 104 may assess fees to the consumer corresponding to the consumer device C(c) 102, the merchant M(m) 106, or a combination thereof. For example, the ROS 104 may assess fees for enrolling entities that become part of the system 100 such as the consumer or the merchant M(m) 106. The ROS 104 may also assess fees for each transmission sent to or received from ROS-C network 120 or ROS-M network 130, or for other transmissions to third parties using other networks. For example, the ROS 104 may assess fees for transmissions between the ROS 104 and the merchant processing system. The ROS 104 may also assess fees for transactions to which an offer has been applied, such as five cents ($0.05 US) per transaction per entity involved in the transaction.

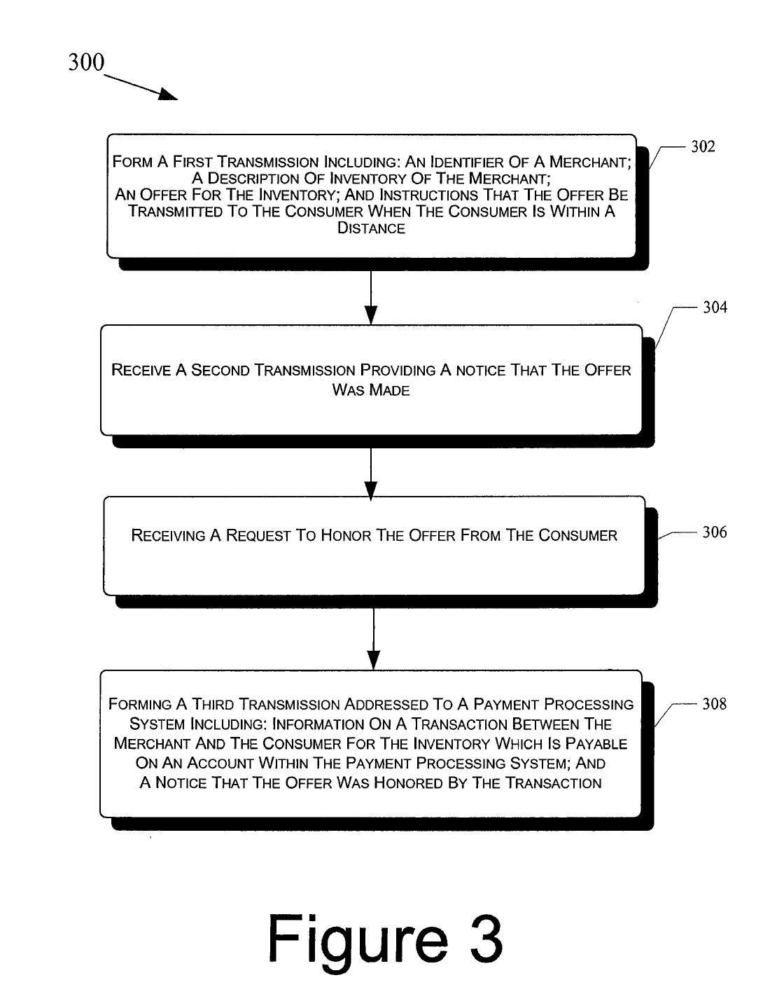

Referring to FIG. 3, a flow chart is used to illustrate an exemplary process 300 for supplying an offer incident to a consumer request for inventory, where the offer is transmitted to the consumer when the consumer is within the predetermined distance from the merchant M(m) 106. Process 300 begins at step 302 where a first transmission is formed. The first transmission may include: the identifier of the merchant M(m) 106; a description of an inventory of the merchant M(m) 106; the offer for the inventory to be made to the consumer, and instructions for transmitting the offer, such as transmitting the offer when to the consumer when the consumer is within the predetermined distance from the merchant M(m) 106.

The identifier of the merchant M(m) 106 may be a reference to the merchant M(m) 106 such that the merchant M(1) 106 can be distinguished from another the merchant M(2) 106. For example, the identifier for the merchant M(m) 106 may be globally unique within the payment processing system such that the merchant M(1) 106 can be distinguished from other of the merchants M(m) 106. The identifier of the merchant M(m) 106 may take the form of a random code; an indicator of a franchiser for one or more the merchant M(m) 106; an indicator of a franchisee store number for the merchant M(m) 106; an indicator of a corporate entity associated with the merchant M(m) 106; an indicator of a merchant category into which the merchant M(m) 106 is classified; or a combination thereof. The identifier for the merchants M(m) 106 may contain information that can categorize the merchants M(m) 106 into a merchant category, such as a retail store, having a corresponding merchant code. For example, the identifier for the merchant M(m) 106 may be “RSTR598183” the first four letters indicating that the merchant is categorized as a Retail SToRe=“RSTR.”

The description of the inventory of the merchant M(m) 106 may be specific or general. The description of the inventory can be specific such as a list of product SKU numbers that the merchant M(m) 106 may have in-stock and is willing to make an offer for. Alternatively, or in combination, the description of the inventory may be general such as product categories (e.g., “hats, hammers, and handbags”) of inventory that the merchant M(m) 106 knows will be in-stock by a certain date. The description can be the quantity or price of goods or services that the merchant M(m) 106 may give offers for. Alternatively, or in combination, the description of the inventory may be a location of the POS of the merchant M(m) 106 at which the inventory may be purchased.

The offer for the inventory in the first transmission may be the offer itself or the business rules that the ROS 104 can use to determine the offer. As stated previously, the merchant M(m) 106 may submit business rules to the ROS 104 to determine the offer. On the other hand, the merchant M(m) 106 may receive a transmission from the ROS 104 via the ROS-M network 130 that includes the request of the consumer, the location of the consumer which may be the real time location of the consumer (e.g., “a consumer is located at 5th Ave and Madison”) or a notice that the consumer is within the predetermined distance (e.g., “a consumer is within your offer's predetermined distance of 1 kilometer”). Given the request and the location of the consumer, the merchant M(m) 106 may determine that the offer is a discount of 10% for the requested inventory. Thereafter, the merchant M(m) 106 may submit a reply transmission to the ROS 104 via the ROS-M network 130 including the determined offer of 10% discount for the requested inventory.

The instructions for transmitting the offer may be a reflection of the conditions of the offer. For example, the offer can be transmitted to the consumer when: the consumer is within the predetermined distance for a predetermined duration of time, the consumer has not redeemed the offer and is within a second predetermined distance, or the consumer has set a predetermined time period for receiving offers, for example. The instructions for transmitting the offer may include instructions to also transmit information about the inventory, such as a level of satisfaction of a consumers that have purchased the inventory or safety features of the inventory of the merchant.

If the inventory of the merchant M(m) 106 becomes unavailable, the merchant M(m) 106 may stop the transmission of the offers or revoke offers that have not been accepted yet. The inventory may become unavailable in situations such as when the merchant M(m) 106 has sold all of the inventory that it may have in its possession, the merchant M(m) 106 may have allocated a specific amount of the merchant's M(m) 106 inventory for the offers it is willing to make, or the inventory may have not reached the merchant M(m) 106 in the time period that the offers were set to be sent. Therefore, after the transmission in the step 302, the merchant M(m) 106 may instruct the ROS 104 to no longer transmit offers to consumers. Alternatively or in combination, the merchant M(m) 106 may instruct the ROS 104 to revoke offers that it has already to consumers but the consumer has not yet has not accepted (e.g., the consumer has not used the offer toward the purchase of the inventory).

At step 304, a second transmission is receiving providing a notice that the offer was made. For example, the location of the consumer device C(c) 102 may trigger the ROS 104 to transmit the offer to the consumer device C(c) 102. Once the transmission is formed and submitted, the merchant M(m) 106 may receive the second transmission that gives the merchant M(m) 106 notice that the offer was transmitted to the consumer requesting the inventory. The notice can be used to prepare for the sale, such as by reserving the inventory for a predetermined period of time, such as a duration of time prior to the expiration of the offer or “for one day.”

The consumer may receive a plurality of the offers from different corresponding merchants M(m) 106. For example, both Neiman Marcus and Saks Fifth Avenue in the mall may offer the consumer a coupon toward the purchase of the pair of shoes. The consumer may relay to the merchant M(m) 106, via the ROS 104, that the consumer would like a different offer. The consumer may state that the consumer has a number of offers and is trying to determine which merchant M(m) 106 is willing to make the best deal. Alternatively or in combination, the consumer may state that the consumer is willing to purchase the pair of shoes at Neiman Marcus if Neiman Marcus is willing to take another 5% off toward the purchase of the pair of shoes independent of whether the consumer received other offers.

At step 306, a request to honor the offer is received from the consumer. The consumer may present a copy of the offer at the merchant's M(m) 106 POS while making a purchase of the inventory and ask the merchant M(m) 106 to apply the value of the offer toward the purchase. For example, the consumer may have received the offer in the form of a digital coupon of 10% off in a transmission from the ROS 104 via the ROS-C 120 network to the consumer device C(c) 102 that may be a mobile phone. At the time of the purchase, the consumer may present an image of the digital coupon to the merchant M(m) 106 and ask that the purchase be deducted by 10%. Alternatively, or in combination, the consumer may receive a transmission having the offer on the consumer device C(c) 102, such as a mobile phone. The consumer may use the mobile phone to transmit to the merchant's M(m) 106 POS both portions of the offer, such as an offer identifier, and an identifier of the account associated with the consumer within the payment processing system for processing the purchase of the inventory between the merchant and the consumer.

The merchant M(m) 106 may validate the offer prior to honoring it. The merchant M(m) 106 may send a validation transmission to the ROS 104 requesting to validate the offer. For example, the ROS 104 may have the confirmation code for the offer. The confirmation code may be sent to the consumer with the offer for the consumer to present to the merchant M(m) 106 at the time of the purchase. The merchant M(m) 106 may have a copy of the confirmation code for the offer; for example, the merchant M(m) 106 may have received the copy of the confirmation code for the offer in the second transmission of step 304. The merchant M(m) 106 may match the confirmation code for the offer received from the consumer with the copy of the confirmation code for the offer received in the second transmission of step 304 in order to validate that the offer is the offer sent from the ROS 104 to the consumer and not forged offer. Alternatively, or in combination, the merchant M(m) 106 may send the confirmation code received from the consumer in a validation transmission to the ROS 104 via the ROS-M network 130. The ROS 104 may have saved a copy of the confirmation code in a database, such as the database S(s) 108. After the ROS 104 receives the validation transmission, the ROS 104 may match the confirmation code the ROS 104 received in the validation transmission with the copy of the confirmation code saved in the database. Thereafter, the ROS 104 may form a transmission addressed to the merchant M(m) 106 indicating whether the match was found or the match was not found. Alternatively, or in combination, the merchant M(m) 106 may send the validation transmission to the payment processing system to match the confirmation code received from the consumer with a copy of the confirmation code that the payment processing system may have saved in a database, such as the storage S(s) 108.

At step 308, a transaction message transmission may be sent to the payment processing system for processing the transaction between the merchant M(m) 106 and the consumer for the inventory. The merchant M(m) 106 may form the transaction message transmission containing information about the transaction, such as the purchase price, the date of the transaction, the account number of the account in the payment processing system, an identifier for the offer that can distinguish the offer from other offers, or a notice that the merchant M(m) 106 has offer has honored the offer for the transaction.

By way of example, and not by way of limitation, an exemplary suitable payment processing system is illustrated in FIG. 4. Referring to FIG. 4, in general, a transaction includes participation from different entities that are a component of a payment processing system 400 including an issuer 402, a transaction handler 404, such as a credit card company, an acquirer 406, a merchant 408 such as the merchant M(m) 106, or a user 410 such as an account holder or the consumer. The acquirer 406 and the issuer 402 can communicate through the transaction handler 404. Merchant 408 may be a person or entity that sells goods or services, such as been described about with reference to the merchant M(m) 106. Merchant 408 include, for instance, a manufacturer, a distributor, a retailer, a load agent, a drugstore, a grocery store, a gas station, a hardware store, a supermarket, a boutique, a restaurant, or a doctor's office. In a business-to-business setting, the user 410 may be a second merchant making a purchase from another merchant 408. Merchant 408 may utilize at least one POS terminal that can communicate with the acquirer 406, the transaction handler 404, or the issuer 402. Thus, the POS terminal is in operative communication with the payment processing system 400.

Typically, a transaction begins with the user 410, such as an account holder or a consumer, presenting a portable consumer device 412, such as the consumer device C(c) 102, to the merchant 408 to initiate an exchange for a good or service. The portable consumer device 412 may include a payment card, a gift card, a smartcard, a smart media, a payroll card, a health care card, a wrist band, a machine readable medium containing account information, a keychain device such as the SPEEDPASS® commercially available from ExxonMobil Corporation or a supermarket discount card, a cellular phone, personal digital assistant, a pager, a security card, an access card, a wireless terminal, or a transponder. The portable consumer device 412 may include a volatile or non-volatile memory to store information such as the account number or an account holder's name.

The merchant 408 may use the POS terminal to obtain account information, such as an account number, from the portable consumer device. The portable consumer device 412 may interface with the POS terminal using a mechanism including any suitable electrical, magnetic, or optical interfacing system such as a contactless system using radio frequency or magnetic field recognition system or contact system such as a magnetic stripe reader. The POS terminal sends a transaction authorization request to the issuer 402 of the portable consumer device. Alternatively, or in combination, the portable consumer device 412 may communicate with the issuer 402, the transaction handler 404, or the acquirer 406.

The issuer 402 may authorize the transaction using the transaction handler 404. The transaction handler 404 may also clear the transaction. Authorization includes the issuer 402, or the transaction handler 404 on behalf of the issuer 402, authorizing the transaction in connection with the issuer's 402 instructions such as through the use of business rules. The business rules could include instructions or guidelines from the transaction handler 404, the user 410, merchant 408, the acquirer 406, the issuer 402, a financial institution, or combinations thereof. The transaction handler 404 may maintain a log or history of authorized transactions. Once approved, merchant 408 will record the authorization, allowing the user 410 to receive the good or service.

Merchant 408 may, at discrete periods, such as the end of the day, submit a list of authorized transactions to the acquirer 406 or other components of the payment processing system 400. The transaction handler 404 may compare the submitted authorized transaction list with its own log of authorized transactions. If a match is found, the transaction handler 404 may route authorization transaction amount requests from the corresponding acquirer 406 to the corresponding issuer 402 involved in each transaction. Once the acquirer 406 receives the payment of the authorized transaction amount from the issuer 402, it can forward the payment to merchant 408 less any transaction costs, such as fees. If the transaction involves a debit or pre-paid card, the acquirer 406 may choose not to wait for the initial payment prior to paying the merchant 408.

There may be intermittent steps in the foregoing process, some of which may occur simultaneously. For example, the acquirer 406 can initiate the clearing and settling process, which can result in payment to the acquirer 406 for the amount of the transaction. The acquirer 406 may request from the transaction handler 404 that the transaction be cleared and settled. Clearing includes the exchange of financial information between the issuer 402 and the acquirer 406 and settlement includes the exchange of funds. The transaction handler 404 can provide services in connection with settlement of the transaction. The settlement of a transaction includes depositing an amount of the transaction settlement from a settlement house, such as a settlement bank, which the transaction handler 404 typically chooses, into a clearinghouse, such as a clearing bank, that the acquirer 406 typically chooses. The issuer 402 deposits the same from a clearinghouse, such as a clearing bank, which the issuer 402 typically chooses into the settlement house. Thus, a typical transaction involves various entities to request, authorize, and fulfill processing the transaction.

Various terms may be used herein, which are to be understood according to the following descriptions:

The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

1. A method comprising:
receiving, via a communication network, a consumer request from a consumer, requesting an offer for sale of requested inventory to the consumer by a merchant, including a consumer requested inducement for the consumer to purchase the requested inventory from the merchant;
matching, via a computing device, the consumer request to a set of merchants having the requested inventory, and determining the existence of at least one offeror merchant from the set of merchants willing to make a first merchant offer to the consumer for the sale of the requested inventory to the consumer, including the consumer requested inducement; and
transmitting, via the communication network, to the consumer, the first merchant offer for the sale of the requested inventory to the consumer, including the consumer requested inducement.

2. The method as defined in claim 1, further comprising receiving, via the communication network, a transmission from the consumer including an identifier of an account associated with the consumer within a payment processing system for processing the purchase of the requested inventory by the consumer from the offeror merchant.

3. The method as defined in claim 2, further comprising receiving, via the communications network, the transmission from the consumer as part of a payment processing system payment authorization regarding a transaction between the offeror merchant and the consumer for the purchase of inventory of a merchant, requesting authorization for payment on the account associated with the consumer within the payment processing system.

4. The method as defined in claim 1, wherein, if the requested inventory of the offeror merchant becomes unavailable, the method further comprises:
transmitting one of a blocking transmission blocking the first merchant offer to the consumer and a withdrawal transmission withdrawing the first merchant offer.

5. The method as defined in claim 1, further comprising:
transmitting, via a communication network, the first merchant offer to the consumer when the consumer is within a first predetermined distance from the offeror merchant.

6. The method as defined in claim 5, further comprising:
transmitting, via a communication network, a second merchant offer for the sale of the requested inventory to the consumer when the consumer is within a second predetermined distance from the offeror merchant, if the transaction between the offeror merchant and the consumer for the purchase of the requested inventory does not occur within a predetermined period of time after the transmission of the first merchant offer.

7. The method as defined in claim 4, wherein the first predetermined distance is selected from a group consisting of:
a predetermined straight line distance;
a predetermined motorized route distance;
a predetermined non-motorized route distance;
a predetermined distance which can be covered within a predetermined time period using a motorized vehicle;
a predetermined distance which can be covered within a predetermined time period using a non-motorized vehicle; and
a predetermined distance which can be covered within a predetermined time period by walking.

8. The method as defined in claim 1, wherein the first merchant offer includes at least one of:
a location of the offeror merchant;
an identifier for the offeror merchant; and
a confirmation code for the first merchant offer.

9. The method as defined in claim 1, wherein:
the incentive is selected from a group consisting of:
a percentage off of the price of the purchase of the requested inventory;
a cash-back from the price of the purchase of the requested inventory; and
a spend-and-get, where the consumer receives at least one of a good and a service based on the purchase of the requested inventory.

10. The method as defined in claim 1, further comprising:
transmitting, via a communication network, to the consumer a description of a level of satisfaction of a plurality of consumers that have purchased, from a plurality of merchants, the requested inventory.

11. The method as defined in claim 2, wherein the first merchant offer is derived at least in part from a parameter selected from the group consisting of:
the first predetermined distance;
a third predetermined distance between the consumer and a competitor of the offeror merchant;
a request for an offer for the requested inventory from the competitor of the offeror merchant;
a sales volume of the competitor of the offeror merchant for the requested inventory as determined by transactions for the requested inventory between the competitor of the offeror merchant and a plurality of offerees each having a corresponding account within a payment processing system, wherein the respective transactions were each payable on the respective corresponding account;
a current quantity of the requested inventory that the offeror merchant has in-stock;
a time that the consumer is within the first predetermined distance;
a duration of time that the consumer is within the first predetermined distance;
a quantity of the requested inventory that the consumer has requested;
a duration of time that the requested inventory has been in the possession of the offeror merchant;
the location of the requested inventory;
transactions of the consumer, the authorization of which was obtained by a transaction handler within a consumer payment processing system in which the consumer has an account; and
a characteristic of the account.

12. The method as defined in claim 1, further comprising:
in response to receiving a request to honor the first merchant offer from the consumer, transmitting to the offeror merchant, via the communication network, a request for a validation of the first merchant offer; and
receiving, via a communication network, a validation of the first merchant offer.

13. A tangible machine readable medium storing instructions that, when executed by a computing device, cause the computing device to perform a method comprising:
receiving a consumer request from a consumer, requesting an offer for sale of requested inventory to the consumer by a merchant, including a consumer requested inducement to the consumer to purchase the requested inventory from the merchant;
matching the consumer request to a set of merchants having the requested inventory, and determining the existence of at least one offeror merchant from the set of merchants willing to make a first merchant offer to the consumer for the sale of the requested inventory to the consumer, including the consumer requested inducement; and
transmitting to the consumer, the first merchant offer for the sale by the offeror merchant of the requested inventory to the consumer, including the consumer requested inducement.

14. The machine readable medium as defined in claim 13, wherein:
the incentive is selected from a group consisting of:
a percentage off of the price of the purchase of the requested inventory;
a cash-back from the price of the purchase of the requested inventory; and
a spend-and-get, where the consumer receives at least one of a good and a service based on the purchase of the requested inventory.

15. The machine readable medium as defined in claim 13, the method further comprising:
transmitting the first merchant offer to the consumer if the consumer is within a first predetermined distance from the offeror merchant;
wherein the predetermined distance is selected from the group consisting of:
a predetermined straight line distance;
a predetermined motorized route distance;
a predetermined non-motorized route distance;
a predetermined distance which can be covered within a predetermined time period using a motorized vehicle;
a predetermined distance which can be covered within a predetermined time period using a non-motorized vehicle; and
a predetermined distance which can be covered within a predetermined time period by walking.

16. The machine readable medium as defined in claim 13, wherein the requested offer is derived at least in part from a parameter selected from the group consisting of:
the first predetermined distance;
a third predetermined distance between the consumer and a competitor of the offeror merchant;
a third offer for the requested inventory from the competitor of the offeror merchant;
a sales volume of the competitor of the offeror merchant for the requested inventory as determined by transactions for the requested inventory between the competitor of the offeror merchant and a plurality of consumers each having a corresponding account within a payment processing system, wherein the respective transactions were each payable on the respective corresponding account;
a current quantity of the requested inventory that the offeror merchant has in-stock;
a time that the consumer is within the first predetermined distance;
a duration of time that the consumer is within the first predetermined distance;
the quantity of the requested inventory that the consumer has requested;
a duration of time that the requested inventory has been in the possession of the offeror merchant;
the location of the requested inventory;
transactions of the consumer, the authorizations of which were obtained by a transaction handler within a consumer payment processing system in which the consumer has an account; and
a characteristic of the account.

17. The machine readable medium as defined in claim 13, the method further comprising:
transmitting the first merchant offer to the consumer when at least one of the following is true: (1) a description of the requested inventory of the offeror merchant is the same as a description of the requested inventory requested by the consumer, (2) an inventory of the offeror merchant is typically used in conjunction with the requested inventory, and (3) an inventory of the offeror merchant complements the requested inventory.

18. The machine readable medium as defined in claim 13, the method further comprising:
transmitting, from the offeror merchant information on a transaction between the offeror merchant and the consumer for the requested inventory which is payable on an account associated with the consumer within the payment processing system.

19. A system comprising:
a communication network configured to receive a consumer request from a consumer, requesting an offer for sale of requested inventory to the consumer by a merchant, including a consumer requested inducement to the consumer to purchase the requested inventory from the merchant; and
a computing device configured to match the consumer request to a set of merchants having the requested inventory, and determining the existence of at least one offeror merchant from the set of merchants willing to make a first merchant offer to the consumer for the sale of the requested inventory to the consumer, including the consumer requested inducement;
wherein the communication network is configured to transmit the first merchant offer to the consumer for the sale by the offeror merchant of the requested inventory to the consumer, including the consumer requested inducement.

20. The system as defined in claim 19, wherein:
the communication network is further configured to transmit the first merchant offer to the consumer when the consumer is within a first predetermined distance from the offeror merchant.
